(19) United States
(12) Patent Application Publication
(10) Pub. No.: US 2010/0299352 A1
(43) Pub. Date: Nov. 25, 2010

(54) NAVIGATION OF CONTACT INFORMATION REPRESENTED AS PAGES CONTAINING A PLURALITY OF CONTACT IDENTIFIERS

(76) Inventors: Martin J. Price, Toronto (CA); Timothy J. Fedy, Toronto (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 12/470,065

(22) Filed: May 21, 2009

(51) Int. Cl. G06F 17/30; G06F 3/048

(52) U.S. Cl. 707/769; 707/E17.014; 715/810; 715/702

(57) ABSTRACT

A system and method for obtaining a unique contact identifier for use by a user device in sending a communication message over a communications network to a target device addressable on the communications network through the unique contact identifier. The system and method comprise a parameter module for receiving at least one search parameter submitted by the user; a search module for submitting a search request including the search parameter for use in searching a storage containing stored contact information including the unique contact identifier, the stored contact information including multiple contact identifiers, and for receiving a search response including a plurality of contact identifiers of the multiple contact identifiers matching the at least one search parameter; a presentation module for presenting to a user interface of the user device a contact information set including the plurality of contact identifiers; and a selection module configured for identifying all respective contact identifiers present in a user selected subset of the contact information set, and for providing the user selected subset including the identified contact identifiers to the user interface for use in selecting the unique contact identifier there from; wherein the selected unique contact identifier is used by the user device for generating the communication message for sending over the communications network to the target device addressed by the unique contact identifier.

The present invention relates to the retrieval and use of contact information for network communications.

### BACKGROUND

In today's information dependent age, efficient retrieval of contact information from extensive, and typically disparate, contact information databases is becoming increasingly important. There currently exists disparate information sources for website contact information, email contact information, telephone and facsimile information, as well as other contact information such as VOIP and SMS. An added complexity for contact information searching and retrieval is an anticipated or otherwise familiar form factor that users expect from search interfaces.

One popular contact information source is the Yellow pages directories. Unfortunately, the current electronic format (e.g. Canada 411) of the Yellow pages is quite dissimilar to the traditional Yellow pages hardcopy format and therefore electronic searching can quickly become difficult due to the lack of contextual information. This difficulty is caused by the sole dependence of keywords for retrieval of contact information from the electronic Yellow Pages directory, wherein incorrect or otherwise unknown keyword search parameters can result in difficult to interpret or otherwise erroneous/undesirable electronic search results.

However, a disadvantage to traditional hardcopy contact information directories is that their contact information can be outdated due to the periodic publication of their content. Further, the association of dynamic content with hardcopy contact information directories is problematic at best.

### SUMMARY

It is an object of the present invention to provide a contact information environment to obviate and/or mitigate at least some of the above-presented disadvantages.

In today's information dependent age, efficient retrieval of contact information from extensive, and typically disparate, contact information databases is becoming increasingly important. There currently exists disparate information sources for website contact information, email contact information, telephone and facsimile information, as well as other contact information such as VOIP and SMS. An added complexity for contact information searching and retrieval is an anticipated or otherwise familiar form factor that users expect from search interfaces. Further, the association of dynamic content with hardcopy contact information directories is problematic at best. Contrary to current systems and methods there is provided a system and method for obtaining a unique contact identifier for use by a user device in sending a communication message over a communications network to a target device addressable on the communications network through the unique contact identifier. The system and method comprise a parameter module for receiving at least one search parameter submitted by the user; a search module for submitting a search request including the search parameter for use in searching a storage containing stored contact information including the unique contact identifier, the stored contact information including multiple contact identifiers, and for receiving a search response including a plurality of contact identifiers of the multiple contact identifiers matching the at least one search parameter; a presentation module for presenting to a user interface of the user device a contact information set including the plurality of contact identifiers; and a selection module configured for identifying all respective contact identifiers present in a user selected subset of the contact information set, and for providing the user selected subset including the identified contact identifiers to the user interface for use in selecting the unique contact identifier there from; wherein the selected unique contact identifier is used by the user device for generating the communication message for sending over the communications network to the target device addressed by the unique contact identifier.

A first aspect provided is a system for obtaining a unique contact identifier for use by a user device in sending a communication message over a communications network to a target device addressable on the communications network through the unique contact identifier, the system comprising: a parameter module for receiving at least one search parameter submitted by the user; a search module for submitting a search request including the search parameter for use in searching a storage containing stored contact information including the unique contact identifier, the stored contact information including multiple contact identifiers, and for receiving a search response including a plurality of contact identifiers of the multiple contact identifiers matching the at least one search parameter; a presentation module for presenting to a user interface of the user device a contact information set including the plurality of contact identifiers; and a selection module configured for identifying all respective contact identifiers present in a user selected subset of the contact information set, and for providing the user selected subset including the identified contact identifiers to the user interface for use in selecting the unique contact identifier there from; wherein the selected unique contact identifier is used by the user device for generating the communication message for sending over the communications network to the target device addressed by the unique contact identifier.

A further aspect provided is a method for obtaining a unique contact identifier for use by a user device in sending a communication message over a communications network to a target device addressable on the communications network through the unique contact identifier, the method including instructions stored on a computer readable medium for execution by a computer processor, the instructions comprising: receiving at least one search parameter submitted by the user; submitting a search request including the search parameter for use in searching a storage containing stored contact information including the unique contact identifier, the stored contact information including multiple contact identifiers; receiving a search response including a plurality of contact identifiers of the multiple contact identifiers matching the at least one search parameter; presenting to a user interface of the user device a contact information set including the plurality of contact identifiers; identifying all respective contact identifiers present in a user selected subset of the contact information set; and providing the user selected subset including the identified contact identifiers to the user interface for use in selecting the unique contact identifier there from; wherein the selected unique contact identifier is used by the user device for generating the communication message for sending over the communications network to the target device addressed by the unique contact identifier.

### BRIEF DESCRIPTION OF THE DRAWINGS

Exemplary embodiments of the invention will now be described in conjunction with the following drawings, by way of example only, in which:

FIG. 1 is a block diagram of components of a contact information environment;

FIG. 2 is an example configuration of the contact information environment of FIG. 1;

FIG. 3 shows an example configuration of a pages engine of the environment of FIG. 1;

FIG. 4a is an example display of pages retrieved by the pages engine of FIG. 1;

FIG. 4b shows a selected region of a page of FIG. 4b;

FIG. 5 is an example configuration of the pages engine and a user device of FIG. 1;

FIG. 6 is a block diagram of an example computing device for implementing components of the environment of FIG. 1;

FIG. 7 is an example of search parameters of the environment of FIG. 1;

FIG. 8 shows an example presentation of contact information of the environment of FIG. 1; and

FIG. 9 is an example operation of the environment of FIG. 1.

### DETAILED DESCRIPTION OF THE PREFERRED EMBODIMENT(S)

### Contact Information System 10

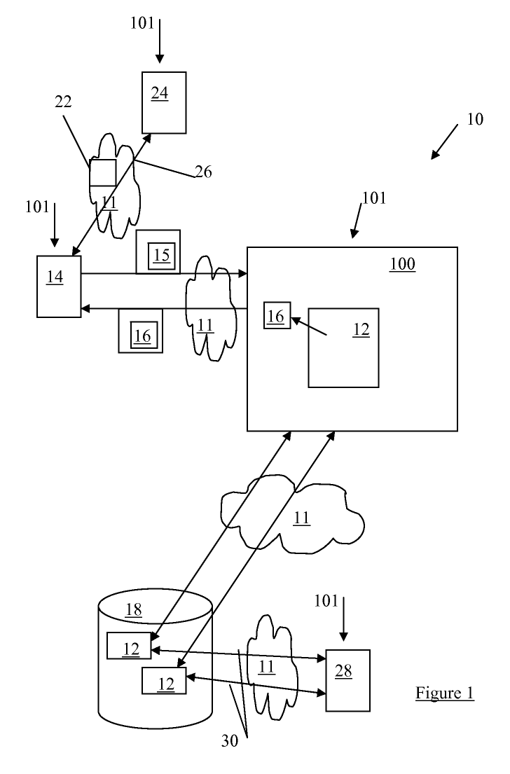

Referring to FIG. 1, shown is a contact information system 10 for facilitating the selection of contact information 12 (e.g. white pages, yellow pages, and/or other contact information collections) by a user 14 of a digital device 101 (e.g. telephone, touch phone, computer, etc.), for use in establishing a network connection between the user device 101 and a target device 24 over a communications network 11.

The user 14 navigates the contact information 12 via a pages engine 100 to select one or more contact identifiers 16 (e.g. telephone number, email address, VOIP number, etc.) that are used as unique contact identifiers 21 for one or more target devices 24 of the network 11. The contact information 12 is resident in a storage 18, being local and/or remote to the pages engine 100, and is accessible by the pages engine 100 over the communications network 11, as further described below.

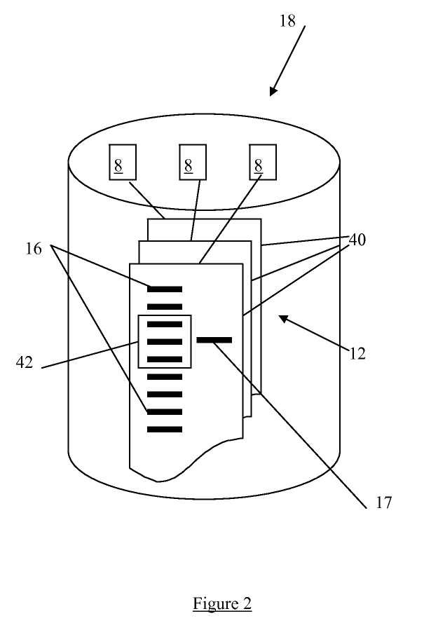

The user 14 submits one or more search parameters 15 (e.g. name of person/company, location/address of person/company, and/or category of person/company, etc.) to the pages engine 100, which is configured for using the parameters 15 to coordinate the selection of the contact identifiers 16 from the contact information 12, as further described below. The search parameters 15 can include the input of search keywords (e.g. business name, personal name, business location/address, personal location/address, business category, etc.), whereby the pages engine 100 responds with one or more pages 40 (see FIG. 2), for example, of the contact information 12 that contain at least some contact identifier(s) 16 matching the submitted input parameters 15. The pages engine 100 facilitates the user 14 to select the unique contact identifier 21 from the plurality of contact identifiers 16 listed on a given page 40, as further described below. Further, it is recognised that the pages 40 can also contain non-matching contact identifiers 17 (i.e. contact identifiers that do not match the submitted parameters 15), such that the non-matching contact identifiers 17 are positioned adjacent to the matching contact identifiers 16 on the page(s) 40.

The unique contact identifier(s) 21 retrieved from the contact identifiers 16 are then used by the user 14 to initiate a network communication 22 (e.g. email communication, text messaging, telephone call, VOIP call, etc.) with a third party 24 associated with the retrieved contact identifier(s) 21. It is recognised that the network communications 22 can be synchronous and/or asynchronous communications, as desired. For example, the contact identifiers 16 can be network location addresses such as but not limited to: telephone numbers; email addresses; VOIP addresses, etc., which are used to establish a network connection 26 (on the network 11) for the network communication 22 between the network device 101 of the user 14 and the network device 101 of the third party 24.

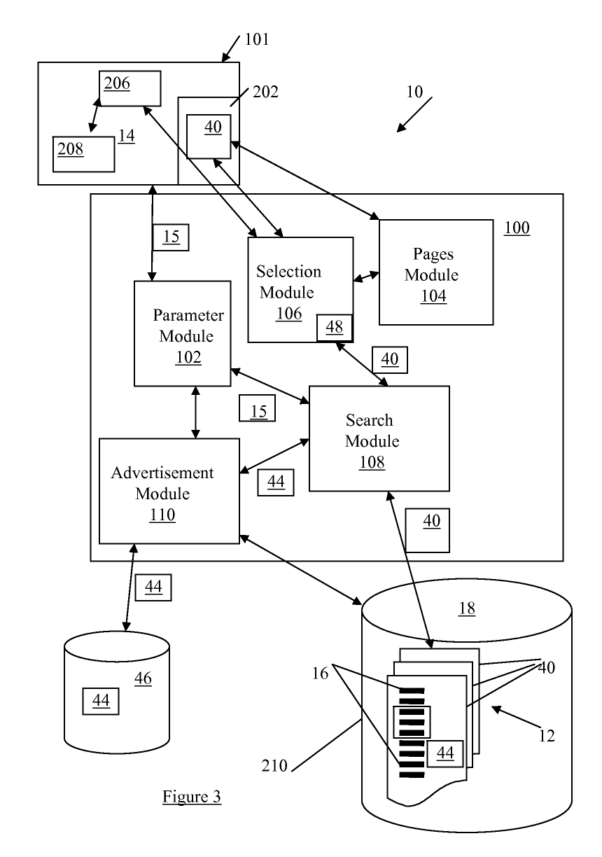

Accordingly, communication between the computer devices 101, e.g. of the user 14, the third party 24, the pages engine 100, and/or the storage 18, is facilitated via the one or more communication networks 11 and implemented by the user 14 through a user interface 202 of the device 101 (see FIG. 3). The system 10 can include multiple user 14 devices 101, multiple pages engines 100, multiple third party 24 devices 101, and one or more coupled communication networks 11, as desired. For example, it is recognised that the communication network 11 can be a telecommunications network 11 that is a network of telecommunications links and nodes arranged so that network communications 22 (e.g. messages) may be passed from one part of the network 11 to another over multiple links and through various nodes, as is known to a person skilled in the art. Further, telecommunications network links (including their endpoints or “nodes”) may in turn be built out of hierarchical transmission systems, as desired. It is recognised that examples of the communication networks 11 can include one or more network types such as but not limited to: a computer network as a group of interconnected computers (e.g. personal area network PAN, local area network LAN, wide area network WAN, virtual private network VPN, and/or any other defined intranets, extranets, etc.); the Internet Network—as a global ‘network of networks’; a Public switched telephone network PSTN; and/or a global Telex network.

Referring again to FIG. 1, a third party entity 28 can provide periodic updates 30 to the data content (e.g. contact identifiers 16, names associated with the identifiers 16, geographical addresses associated with the identifiers 16, dynamic advertising content 44, etc.) of the contact information 12, thus providing for updated contact identifiers 16 and associated data in the pages 40 of the contact information 12. For example, one embodiment of the third party engine 28 can be an advertisement module 110, as further described below, as separate/remote to the pages engine 100 and/or incorporated as part of the pages engine 100, as desired. It is also recognised that the pages engine 100 can be hosted on the user 14 device 101, and/or the pages engine 100 can be hosted on a device 101 separate from, yet coupled to, the user 14 device 101 over the network 11.

### Contact Information 12

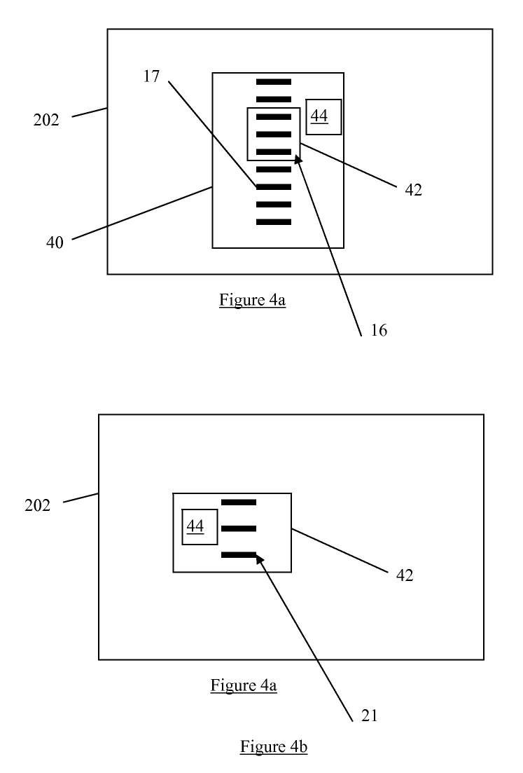

Referring to FIG. 2, the contact information 12 comprises a series/list of contact identifiers 16 published on a collection of pages 40, for example, with optional advertisement content 44, that are configurable (or already configured) for display and navigation on the user interface 202 (see FIG. 4a,b) by the user 14 device 101, on a page by page basis, for example. The navigation of the pages 40 can be done in a hierarchical fashion (e.g. via alphabetical and/or numerical order) between pages 40 as well as between individual contact identifiers 16 on the page(s) 40. The contact identifiers 16 are displayed/listed in the pages 40 beside their corresponding name(s) of the individual/business that the user 14 desires to contact via the network connection 26 (see FIG. 1). For example, the contact identifier 16 can be an e-mail address that identifies a location on the network 11 to which e-mail messages 22 can be delivered, for example as a unique identifier of the form user name@domain name specifying a virtual location to which e-mail can be sent. Further, the contact identifier 16 can be a sequence of digits used to identify a particular destination telephone/facsimile machine in the network 11. Further, the contact identifier 16 can identify a particular computer for use in facilitating VOIP communication 22. As discussed above, it is recognised that the pages 40 are of a predefined formatted layout for the contact identifiers 16,17 and the pages 40 can contain non-matching contact identifiers 17 (i.e. contact identifiers that do not match the submitted parameters 15), such that the non-matching contact identifiers 17 are positioned adjacent to the matching contact identifiers 16 on the page(s) 40. The non-matching contact identifiers 17 are included in the contact information 12 as contextual information for the contact identifiers 16 that matched the submitted parameters 15.

It is recognised that the contact information 12 can be a digital format of contact information traditionally published in hard copy (e.g. telephone directory) or on physical media such as CD-ROM. It is recognized that the contact information 12 can be distributed over a plurality of storages 18 that are accessible by one or more pages engine(s) 100 over the network 11, either directly or indirectly through third party information servers (not shown). For example, the pages engine(s) 100 can interact with a number of directory servers, such that each of the servers specializes in contact information 12 associated with a defined category. Examples of the categories are such as but not limited to: geographic region (e.g. selected citywide, province-wide, statewide directories); business category (e.g. wholesale, retail, defined consumer products/services, etc.); etc. Accordingly, the pages engine 100 can be represented as one or more coupled pages engines 100 for accessing one or more storages 18 to retrieve contact information 12 matching the submitted parameters 15. For example, one pages engine 100 can be used as a portal by the user to access the contact information 12 available to other pages engines 100 connected to the portal pages engine 100 via the network 11, as desired.

The user 14 interacts with the pages engine 100 (see FIG. 1) to facilitate navigation of the pages 40 on the user interface 202, for locating the desired unique contact identifier 21 from a subset 42 of the series/list of contact identifiers 16 displayed on a selected page 40 of the contact information 12, as further described below. It is recognised that the full list of contact identifiers 16 (i.e. included as data content of the pages 12) are distributed over the collection of pages 40 that comprise the contact information 12. Examples of the directory format of the pages 40 are such as but not limited: a personal telephone directory (e.g. white pages); a telephone business directory (e.g. Yellow pages™); an email address listing directory; a government directory (e.g. blue pages); or a combination thereof. It is also recognised that the pages 40 of the contact information 12 can contain a plurality of different types of contact identifiers 16 (e.g. telephone numbers, facsimile numbers, email addresses, and/or VOIP addresses, etc.), as well as any advertising content 44 that is added to the contact information 12 by the advertizing module 110 (see FIG. 3) and/or third party entity 28.

For example, the contact information 12 can include telephone directories of a predefined format that have pages 40 (in numerical order) of personal (e.g. alphabetized listings) of phone numbers distributed over the series of pages 40. These telephone directories (also called a telephone book and phone book) are listings of telephone subscribers in a geographical area and/or subscribers to services provided by an organization that publishes the directory. For example, subscriber names are generally listed in alphabetical order, together with their postal or street address and telephone number. Every subscriber in the geographical coverage area is usually listed, unless they have requested an unlisted telephone number.

The contact information 12 can also include telephone directories of a predefined format that have pages 40 (in numerical order) of business (e.g. alphabetized listings) phone numbers and other contact identifiers 16 in business advertisement formats distributed over the series of pages 40, for example. The business phone number directories (e.g. Yellow Pages™) can contain the contact identifiers 16 categorized according to the product or service provided. The business phone number directories are a print directory (in electronic form) which provides an alphabetical listing of businesses within a specific geographical area (e.g., Greater Toronto), which are segregated under headings for similar types of businesses (e.g., Lawyers, Golf, etc.). These directories can be published or otherwise made available online (e.g. in the storage 18) by the local phone company, and/or other numerous independent directory publishers. Some business phone number directories can be focused on a particular demographic. It is also recognized that the business contact information 12 can include advertisement information 44 associated with the contact identifiers 16 by the advertisement module 110. For example, the advertisement information 44 can be an advertised special (e.g. product promotion) that is displayed adjacent to the contact information 12 matching the submitted parameters 15.

It is recognized that the advertisement engine 110 can be configured to selectively position or otherwise include the advertisement information 44 in the content of the pages 40, so as to only include that advertisement information 44 associated (e.g. adjacent to) with contact identifiers 16 (and relevant contact information 12) matching the submitted parameters 15. For example, in a page 40 of contact information 12 displayed on the user 14 computer 101, the pages engine 100 (e.g. via the advertisement module 110) would include advertisement information 44 with those contact identifiers 16 matching the submitted parameters 15 and would not include advertisement information 44 associated with the non-matching contact identifiers 17 (e.g. to filter out and advertisement information 44 associated with the non-matching contact identifiers 17 if already present in the contact information 12 of the page 40 retrieved from the storage 18) prior to display/presentation of the page 40 to the user 14, as further described below.

The contact information 12 can also include telephone directories that have pages 40 of specified agency (e.g. alphabetized listings) phone numbers and other contact identifiers 16, for example a telephone directory listing of specified agencies (e.g. government agencies as Blue pages) and other official entities, along with specific offices, departments, or bureaus located therein. The agency directories can include state, federal, and local offices, including service districts such as school districts, port authorities, public utility providers, parks districts, fire districts, and the like. The agency directories can also provide information about agency services, in addition to officials' names, addresses, telephone numbers, and other contact information.

Accordingly, in view of the above, the pages 40 of the contact information 12 are configured to represent or otherwise emulate the actual content of the pages of the contact information directories. For example, the pages 40 would be formatted to represent the actual pages (including similar data content) of the physical Yellow and/or White Pages. Therefore, it is recognised that each page 40 of the contact information 12 may contain contact identifiers that do not match (i.e. non-matching contact identifiers 17) the search parameters 15 submitted by the user 14 to the pages engine 100.

### Pages Engine 100

Referring to FIG. 3, shown is an example block diagram of the pages engine 100, which can include a parameter module 102 for receiving the search parameters 15 from the user 14, a pages module 104 for presenting the pages 40 (e.g. for selecting a particular page 40 for display on the user interface 202 similar to turning the pages of a physical book), for example, (corresponding to the search parameters 15) for presentation on the user interface 202 of the user device 101, a selection module 106 for facilitating navigation of the pages 40 by the user 14 to provide for selection of one or more contact identifiers 16 from the plurality of contact identifiers 16,17 displayed in the page(s) 40, a search module 108 configured for using the search parameters 15 for searching the contact information 12 stored in the storage(s) 18 to obtain the corresponding pages 40 for display to the user 14, and an advertisement module 110 for obtaining advertisements 44 (e.g. from an advertisement storage 46) for use in inserting and/or otherwise formatting (e.g. selective insertion) the advertisements 44 as advertisement content into the data content of the pages 40 displayed on the user interface 202.

### Parameter Module 102

Referring again to FIG. 3, the parameter module 102 is configured for receiving the search parameters 15 from the user 14. The search parameters 15 are provided to the search module 108, for use in searching through the contact information 12 available in the storage(s) 18 accessible via the network 11 (see FIG. 1). The parameter module 102 can also make the submitted parameters 15 available to the advertisement module 110 for use in formatting of the advertisement information 44.

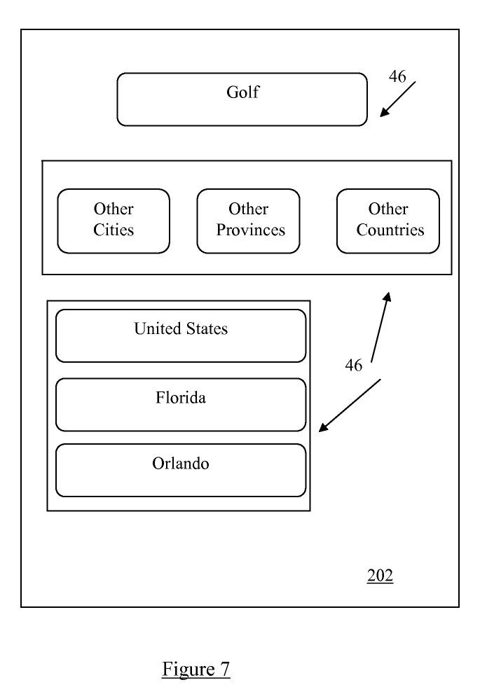

Further, referring to FIG. 7, parameter module 102 can also be configured to present the user 14 (on the user interface 202) with one or more predefined search options 46 to help facilitate the search experience of the user 14. For example, initially presented search options 46 can include selectable options 46 (for use as parameters 15 once selected by the user) such as but not limited to: personal contact, business contact, geographic region (e.g. city/country, business categories, etc.). It is recognised that the search options can be presented as predefined icons, text boxes for user entry of alpha-numeric search string(s), etc., as desired.

### Search Module 108

Referring again to FIG. 3, the search module 108 is configured for obtaining one or more pages 40 from the stored contact information 12 which contain(s) contact identifiers 16 matching (and optionally contact identifiers 17) the search parameters 15 received from the user 14. For example, the search parameters 15 can include the name of a desired person/business and a believed geographic location of the desired person/business (e.g. John Smith on Toronto St. in Toronto Canada, golf courses in Ontario Canada, etc.). The search module 108 obtains the one or more pages 40 including contact identifiers 16 matching the search parameters 15 (e.g. three pages of golf course listings in the Ontario region) and then passes the pages 40 to the pages module 104. It is recognised that the obtained pages 40 will contain a plurality of contact identifiers 16 for subsequent selection by the user 14.

It is recognised that the obtained pages 40 may also include contact identifiers 17 that do not match the search parameters 15, but are otherwise included in the data content of the pages 40 that also include contact identifiers 16 that match the search parameters 15. For example, one or more telephone pages 40 containing a list of telephone numbers (e.g. contact identifiers 16) matching all John Smiths in Toronto may be submitted to the user 14 for display, such that the user 14 is provided with contextual information for navigating the contact identifiers 16 in the displayed pages 40, similar to an actual telephone book in that not all names on a particular page will have the same last name.

It is also recognised that the search module 108 can interact with other pages engines 100 that have access to storages 18 (containing contact information 12 potentially relevant to the submitted parameters 15) that are not directly connected/coupled to the pages engine 100 (e.g. portal engine 100) in direct communication with the user 14. In this example, the search experience of the user 14 would appear seamless in terms of access to a plurality of pages engines 100, as the user would submit the search parameters 15 and receive a collection of contact information 12 from one or more pages engines 100, as facilitated by the portal pages engine 100.

For example, the contact information 12 can be stored in the storage 18 with a series of associated metadata 8 (e.g. tags) (see FIG. 2) that can be used to match the submitted parameters 15 (e.g. the search module 108 or other third party search engine can perform a match operation of the submitted parameters 15 with the metadata 8 for each of the relevant pages 40 of the contact information 12 in the storage(s) 18). One example is where each page 40 of the contact information 12 has a set of metadata 8 representing the content of the information contained in the respective page 40 (e.g. country, city, product/service category, personal/business names/addresses, etc.). For example, in the case of the Yellow Pages™ information, the metadata 8 can include all product/service categories of the contact information 12 resident/included in the respective page 40.

### Pages/Presentation Module 104

Referring again to FIG. 3, the pages module 104 (also referred to as presentation module 104) formats the returned pages 40 (via the search module 108) for presentation on the user interface 202. For example, the pages module 104 can present the user 14 with the retrieved contact information 12 as a series of pages 40 for subsequent navigation, as inter-page and/or intra-page navigation via the selection module 106, for facilitating selection of one or more desired contact identifiers 16 resident in the displayed pages 40 as the selected unique contact identifier(s) 21 (i.e. for use in establishing or otherwise communicating with the target device 24 addressable by the unique contact identifier(s) 21 on the network 11). The selected unique contact identifier(s) 21 are then provided to a command module 206 for interacting with a modem module 208 of the user device 101, as further described below.

For example, the pages module 104 can facilitate the interactive display of the pages 40 to the users 14 as browsing through a virtual publication in 3D turning page animation, as if the user had a hardcopy of the electronic pages 40 in front of them. The pages module 104 can facilitate the user 14 experience of flipping through the pages 40 on the user interface 202 (flip page animation—e.g. using Adobe's™ Flash technology). The virtual page-turning configured pages 40 provides the user 14 with the ability to turn the pages 40 by simply clicking or dragging the page 40 via the user interface 202. For example, users 14 may prefer to view the information content 12 of the pages 40 by this method rather than navigating a website or scrolling through an electronic document.

### Selection Module 106

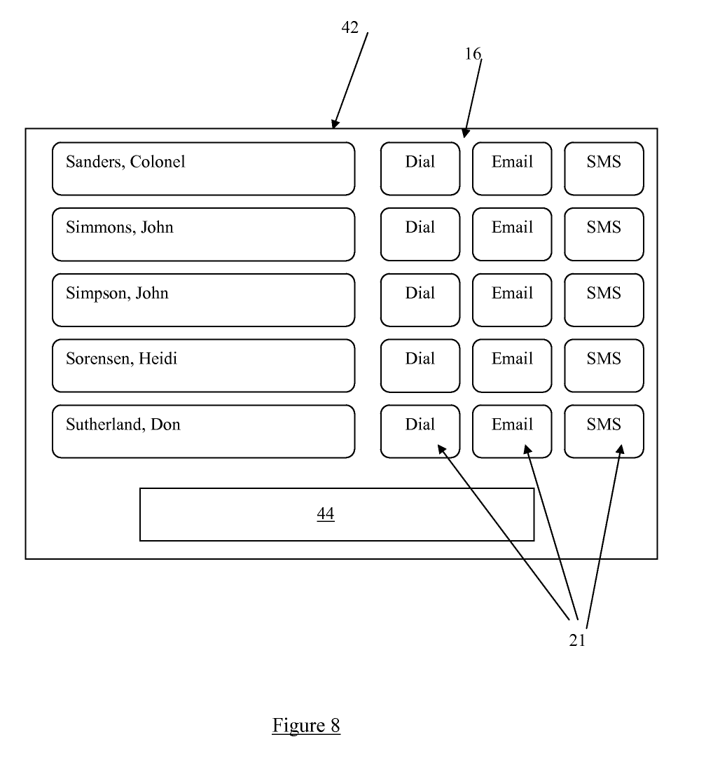

Referring again to FIG. 3, the selection module 106 facilitates selection of one or more contact identifiers 16 from the displayed pages 40. For example, referring to FIG. 4a, the user is presented or otherwise selects one of the pages 40 displayed on the user interface 202. The selected page 40 is noted by the user 14 (e.g. visually) to contain a desired contact identifier 16 in a region 42 of the page 40. The user selects the region 42 (e.g. for example by touching the screen of the user interface 202 in the vicinity of the desired contact identifier 16, using a mouse or other pointer of the user interface 202 to select the region 42, etc.). The selection module 106 can then identify all contact identifiers 16 (e.g. via automated character recognition as is known in the art) in the selected region 42 (e.g. of a predefined size adjacent to a point on the displayed page 40 selected by the user 14) and displays each of the identified contact identifiers 16 as a selectable identifier 21 (e.g. as a hyperlink, as an icon, etc.), as is shown in FIG. 4b, such that the selected region 42 is displayed as a user selected subset 42 of the contact information content 12 of the page 40. For example, the selection module 106 can display a “dial icon” or other selection icon next to each of the unique contact identifiers 21 of the selected region 42, and/or the unique contact identifiers 21 can be the selectable icon themselves. An example of the displayed selected region 42 of the page 40 is shown in FIG. 8.

Accordingly, the user selected subset (user selected region 42) can include all contact identifiers 16 in the user selected region 42 of the page 40 of the series of pages 40, such that the region 42 is of a predefined size in the vicinity of a location (on the page 40) selected by the user 14. It is also recognised that the contents of the user selected subset 42 can be presented on the user interface 202 in enlarged font in relation to the font size of the content of the contact information set 12 of the pages 40 from which the region 42 was selected, so as to facilitate contextual navigation of the retrieved information content 12 and selection of the unique contact identifiers 21.

It is recognised that the selection module 106 can be configured to automatically identify or otherwise differentiate characters (e.g. alphanumeric characters) that represent contact identifiers 16 in the data content of the selected region 42 as compared to other contact data that does not represent contact identifiers 16 in the region 42. The selection module 106 can be configured to disregard characters representing information not applicable for use as contact identifiers 16 (e.g. names, addresses, etc.) and to instead identify telephone numbers, VOIP numbers, email addresses that match predefined contact identifier 16 character patterns 48. For example, the selection module 106 can use a pattern 48 of ###-###-#### (i.e. three digits followed by three digits followed by four digits) to differentiate telephone numbers from address numbers, a pattern 48 of alphanumeric characters separated by a “@” and a “.com” or other extension to differentiate email addresses from other text representing names, addresses, etc. Once identified in the region 42, the selectable identifiers 21 are presented to the user 14 on the user interface 202 for selection. For example, the selection module 106 can be configured to automatically identify those contact identifiers 16 located in the selected region 42 while disregarding any contact information 12 content external to the selected region 42, thus helping to provide for performance efficiency of the presentation of the selectable identifiers 21 on the user interface 202 of the user device 101. Therefore, the selection module 104 facilitates selection by the user 14 of contact identifiers 16 only in the region 42 as the unique identifier 21, while not allowing for selection of contact identifiers 16 as the unique identifier 21 outside of the region 42, as displayed on the user interface 202.

Referring again to FIG. 3, once selected, the selection module 106 sends the selected contact identifier 21 to the command module 206 associated with the modem 208 of the user device 101. It is recognised that the command module 206 can be combined as part of the modem module 208 or separate, as desired. Further, it is recognised that the command module 206 can be part of, or separate from, the pages engine 100, as per the configuration of the communication device 101 of the user 14. For explanation purposes only, the following description is based on the example of the command module 206 as part of the user device 101.

Referring again to FIG. 3, The command module 206 communicates with the selection module 106 of the pages engine 100 for obtaining the destination contact identifier 21 (e.g. telephone number, email address, or other defined network 11 address), which facilitates communication between the communication device 101 of the user 14 and the respective target device 24 (identified by the contact identifier 21) over the communications network 11.

### Command Module 206

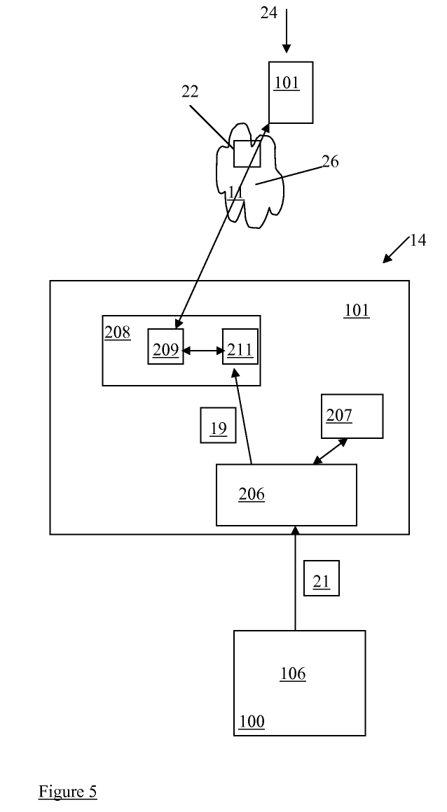

Referring to FIG. 5, the command module 206 includes a command set 207 (e.g. including instructions for picking up and hanging up the phone, dialing numbers, and answering calls) that is used to translate or otherwise format the contact identifier 21 (as provided by the selection module 106) for sending to the modem of the user device 101. For example, the command set 207 can be the basic Hayes command set that is the basis for computer control of most modern modems 208.

The commands themselves can be from the Hayes command set, also known as Hayes AT commands. There are different views to understand the meanings of “AT”. Some call it “Attention Telephone”, whereas others interpret it as “Attention Terminal” commands. AT commands allow giving instructions to both mobile devices and ordinary landline telephones (e.g. the target 24 device 101 identified by the selected contact identifier 21). The commands are sent by the command module 206 to the device's (e.g. a touch phone) modem 208, which can be a GSM modem or PC modem, for example.

It is recognised that the commands 207 can be used for operations that are usually done from the keypad, for instance calling a number (as represented by the contact identifier 21), sending, reading, or deleting an SMS, setting the SMSC number, looking for a GPRS access point, reading and deleting phonebook data, reading the battery status, reading the signal strength, and so on. When one wants to make a PC-based application to interface a mobile phone using USB, IR, or Bluetooth, these commands 207 are used to communicate with mobile phones. Basically such commands 207 are the application layer of MBUS or FBUS commands. Example AT commands 207 are, such as but not limited to: Call control; Command Description; ATA Answer command; ATD Dial command as configured with the selected contact identifier 21; ATH Hang up call; ATL Monitor speaker loudness; ATM Monitor speaker mode; ATO Go on-line; ATP Set pulse dial as default; ATT Set tone dial as default; AT+CSTA Select type of address; and AT+CRC Cellular result codes.

It is also recognised that the commands 207 can be used to provide for operation of the modem 208 for making network connections 26 (see FIG. 1) other than traditional telephone calls 22, such as email communications and/or VOIP communications 22. In this example, the selected contact identifier 21 would represent an email address or a VOIP address, for use by the module 208 in establishing the network connection 26 for facilitating transmission of the communication(s) 22 over the network 11. For example, SkypeIn commands 207 allows Skype users to receive calls on their computers 101 dialed by regular phone subscribers to a local Skype phone number voice over IP voice calls and teleconferences. One main difference between Skype and standard VoIP clients 101 (as facilitated by the modem 208) is that Skype operates on a peer-to-peer model rather than the more usual client-server model.

### Modem 208

Referring again to FIG. 5, the modem 208 of the user device 101 is used to set up the network connection 26 between the user's 14 device 100 and the device 101 of the target 24 identified by the selected contact identifier 21, based on the commands 207 including the contact identifier 21 that are received from the command module 207. The modem 208 (from modulator-demodulator) is referred to as a device that modulates an analog carrier signal to encode digital information, and also demodulates such a carrier signal to decode the transmitted information. The goal is to produce a signal 22 that can be transmitted easily over the network connection 26 and decoded to reproduce the original digital data. Modems 208 can be used over any means of transmitting analog signals, for example, from driven diodes to radio.

For example, the modem 208 can be configured to have a data pump 209 and a controller 211. The data pump 209 regulates the transforming of digital signals into analog and analog into digital, as used in the connection 26. The controller 211 tells the modem 208 how to behave/connect and how to interpret initialization strings, as directed by the received commands 207. A hardware modem 208 has hardware chips do both of these functions, while a software modem 208 has software on the computer device 101 perform the same tasks. For example, software modems 208 are sometimes called WinModems. Such as Controller less and HSP modems. Controller less modems 208have software do the part of the controller 211, but the data pump 209 is still hardware. HSP modems 208 are completely software driven except for the most basic functionality. In an HSP modem 208, both the controller 211 and the data pump 209 are in software.

Another definition of the modem 208 is a Smart modem, wherein the computer of the device 101 dials the target device 24 directly by sending the modem 208 a command including the contact identifier 21, thus eliminating for example the need for an associated phone for dialing and the need for an acoustic coupler.

A typical session of the modem 208 consists of powering up the modem 208 (often inside the computer device 101 itself) which automatically assumes command mode, then sending the modem 208 the command 207 for “dialing” or otherwise establishing the connection 26 via the contact identifier 21 (e.g. a telephone number). After the connection 26 is established to the remote modem (e.g. of the target device 24), the modem 208 automatically goes into data mode, and the user 14 can send and receive data. When the user 14 is finished, an escape sequence, e.g. “+++” followed by a pause of about a second, is sent to the modem 208 by the command module 208 to return the modem 208 to command mode, and the command ATH to hang up the phone is sent.

### Advertisement Module 110

Referring again to FIG. 3, the advertisement engine 110 is configured to facilitate or otherwise manage the format and/or content of the advertisement information 44 included in the retrieved contact information 12 that is presented to the user 14. The advertisement module 110 can obtain additional advertisement content 44 from the advertisement storage 46 for use in dynamically updating the advertisement information contained in the contact information 12. The advertisement engine 110 can be configured to selectively position or otherwise include the advertisement information 44 in the content of the pages 40, so as to only include that advertisement information 44 associated with contact identifiers 16 (and relevant contact information 12) matching the submitted identifiers 15 for example, the advertisement content 44 in Yellow page 40 format (i.e. the contact information 12 is embodied in the pages 40 as a series of Yellow pages directory entries) would be embodied as ads that can have a selectable promo button inside each yellow pages entry, which a vendor (originating the content for pages entry 40) can use to advertise any specials or promotions that the vendor wishes to promote via the information content 12 available to the user device 101 via the pages engine 100.

For example, in a page 40 of contact information 12 displayed on the user 14 computer 101, the pages engine 100 (e.g. via the advertisement module 110) would include advertisement information 44 with those contact identifiers 16 matching the submitted parameters 15 and would not include and advertisement information 44 associated with the non-matching contact identifies 17 (e.g. to filter out and advertisement information 44 associated with the non-matching contact identifiers 17 if already present in the contact information 12 of the page 40 retrieved from the storage 18) prior to display/presentation of the page 40 to the user 14. Accordingly, the advertisement module 110 can be used to filter or otherwise selectively associate advertisement content 44 with contact identifiers 16 matching one or more of the submitted parameters 15. This selective association (for presentation/display on the user interface 202) performed by the advertisement module 110 can help to declutter or otherwise restrict the amount of content displayed in the page 40 and to therefore facilitate the user 14 to concentrate on locating the matching contact identifiers 16 (and associated advertisement information 44) on the page 40.

### Computing Devices 101

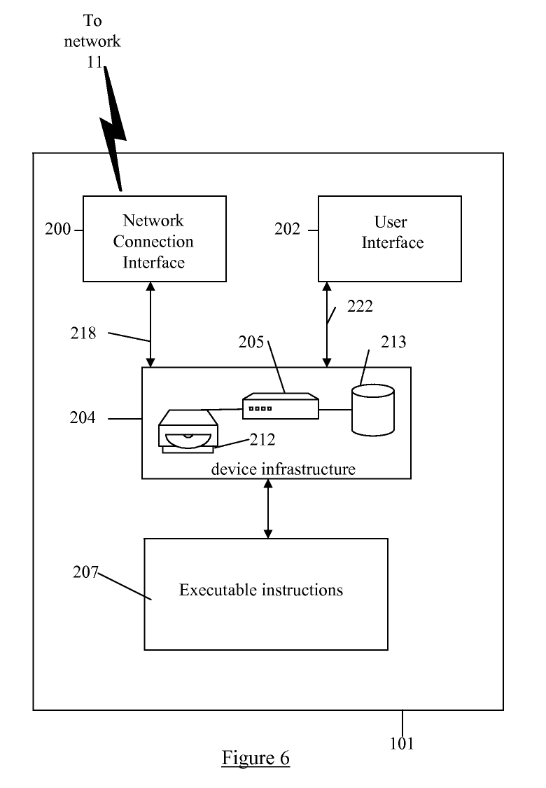

Referring to FIGS. 1 and 6, each of the above-described components of the system 10, e.g. the user 14 device 101, the target 24 device 101, the pages engine 100, can be implemented on one or more respective computing device(s) 101. The devices 101 in general can include a network connection interface 200, such as a modem 208, coupled via connection 218 to a device infrastructure 204. The connection interface 200 is connectable during operation of the device 101 to the communication network 11 (e.g. an intranet and/or an extranet such as the Internet, including wireless networks), which enables the devices 101 to communicate with each other as appropriate. The network 11 can support the communications between the pages engine 100 and the user device 101, and between the user device 101 and the target device 101 of the system 10. It is recognised that the functionality of the pages engine 100 can be hosted on the user device 101 itself, hosted on a device 101 remote to the user 14 via the network 11, or a combination thereof.

Referring again to FIG. 6 the devices 101 can also have the user interface 202, coupled to the device infrastructure 204 by connection 222, to interact with the user 14 (in the case of the user device 101). The user interface 202 is used by the user 14 of the device 101 to view and interact with the pages engine 100, as well in communication of the network communications 22 with the target device 24. The user interface 202 can include one or more user input devices such as but not limited to a QWERTY keyboard, a keypad, a track-wheel, a stylus, a mouse, a microphone and the user output device such as an LCD screen display and/or a speaker. If the screen is touch sensitive, then the display can also be used as the user input device as controlled by the device infrastructure 204. For example, the user interface 202 for the devices 101 used by the users 14 can be configured as a touch screen to facilitate navigation/selection of the pages 40 and their contact identifier 16,17 content.

Referring again to FIG. 6, operation of the devices 101 is facilitated by the device infrastructure 204. The device infrastructure 204 includes one or more computer processors 205 and can include an associated memory 213 (e.g. a random access memory). The computer processor 205 facilitates performance of the device 101 configured for the intended task through operation of the network interface 200, the user interface 202 and other application programs/hardware 207 (e.g. pages engine 100, modem 208, command module 206, etc.) of the device 101 by executing task related instructions. These task related instructions can be provided by an operating system, and/or software applications 207 located in the memory 213, and/or by operability that is configured into the electronic/digital circuitry of the processor(s) 205 designed to perform the specific task(s).

Further, it is recognized that the device infrastructure 204 can include a computer readable storage medium 212 coupled to the processor 205 for providing instructions to the processor 205 and/or to load/update client applications 207 and the pages engine 100 if locally accessed by the user. The computer readable medium 212 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 213. It should be noted that the above listed example computer readable mediums 212 can be used either alone or in combination.

Further, it is recognized that the computing devices 101 can include the executable applications 207 (e.g. engine 100, module 206, modem 208) comprising code or machine readable instructions for implementing predetermined functions/operations including those of an operating system, for example. The processor 205 as used herein is a configured device and/or set of machine-readable instructions for performing operations as described by example above. As used herein, the processor 205 may comprise any one or combination of, hardware, firmware, and/or software. The processor 205 acts upon information by manipulating, analyzing, modifying, converting or transmitting information for use by an executable procedure or an information device, and/or by routing the information with respect to an output device. The processor 205 may use or comprise the capabilities of a controller or microprocessor, for example. Accordingly, any of the functionality of any of the modules (and subsets thereof) of the pages engine 100, the modem 208, and/or the command module 206 may be implemented in hardware, software or a combination of both. Accordingly, the use of a processor 205 as a device and/or as a set of machine-readable instructions is referred to generically herein as a processor/module for sake of simplicity.

It will be understood that the computing devices 101 of the users may be, for example, personal computers, personal digital assistants, and mobile phones. Server computing devices 101 can be configured for the pages engine 100, as desired. Further, it is recognised that each computing device 101, although depicted as a single computer system, may be implemented as a network of computer processors, as desired.

### Operation of the System 10

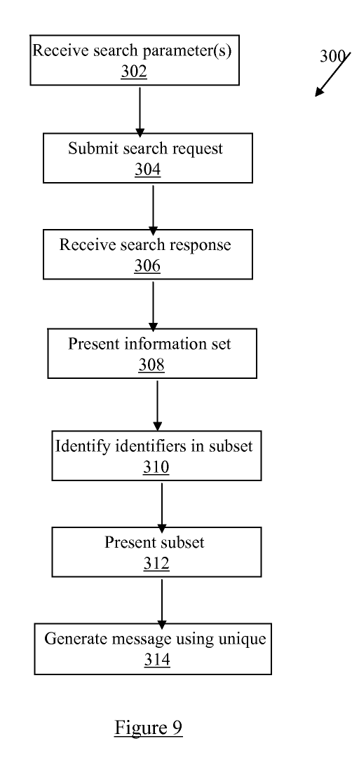

Referring to FIGS. 1, 3 and 9, shown is an example operation 300 of the pages engine 100 in interaction with the device 101 of the user 14, for obtaining a unique contact identifier 21 for use by the user 14 device 101 in sending the communication message 22 over the communications network 11 to the target device 24 addressable on the communications network 11 through the unique contact identifier 21.

At step 302, the parameter module 102 receives at least one search parameter 15 submitted by the user 14. At step 304, the search module 108 submits a search request including the search parameter 15 for use in searching the storage 18 containing stored contact information 12 including the unique contact identifier 21, the stored contact information 12 including multiple contact identifiers 16. At step 306, the search module 108 receives a search response including a plurality of contact identifiers 16 of the multiple contact identifiers 16 matching the at least one search parameter 15. At step 308, the pages module 104 presents to the user interface 202 of the user device 101 a contact information set 40 including the plurality of contact identifiers 16. At step 310, a selection module 106 identifies all respective contact identifiers 16 present in a user selected subset 42 of the contact information set 40. At step 312, the user selected subset including the identified contact identifiers 16 is presented to the user interface 202 for use in selecting the unique contact identifier 21 there from. At step 314, the command module 206 receives the unique contact identifier 21, which is used by the user device 101 for generating the communication message 22 for sending over the communications network 11 to the target device 24 addressed by the unique contact identifier 21.

### Alternative Embodiments

It is also recognised that an alternative operation of the pages engine 100 is where the user 14 touches the yellow pages icon, for example, touches other search parameter 15 selections (e.g. other countries—USA, state, city, type text search string(s)—e.g. law which would take you to lawyers in Yellow pages 40), for example, with a final search performed by either browsing the lawyer Yellow pages 40 or finding some specific firm or lawyer. The final search could be facilitated through the parameter module 102 by the user 14 typing further search strings (e.g. first few letters of firm or name desired) so as to have an even faster search than having the yellow pages 40 in front of the user 14 because the additional search strings can end the search immediately. Accordingly, the pages engine 100 can be configured to use search strings via the parameter module 102 to find an absolute specific at the end and/or being able to flip and browse pages 40 of the contact information 12 retrieved from the storage 18.

A further example operation of the pages engine 100 is as follows for a Yellow Pages application (or other directory as appropriate). The user 14 simply touches a Yellow Pages icon on the user interface 202 which can default automatically to the local Yellow pages 40. The user 13 then types in the 1st few letters of the key word (e.g. search parameter 15) until the parameter module 102 provides search options 46 as complete words/phrases matching the inputted letters, i.e. the user 14 sees what they are searching for, and the user 14 touches the word and they are at the page 40 as if they are looking at the corresponding Yellow pages book (as facilitated by the modules 104, 108 as described above). Using the module 104, the user 14 can flip the pages 40 and browse by simply dragging their finger across the top right corner to the left of the user interface 202, for example. When the user 14 sees a directory entry they want, they simply touch the region 42 near the entry and an enlarged sub-box 42 appears on the user interface 202 for better viewing/selection with the contact identifiers 16 associated with that entry (or other adjacent entries if room is available in the region 42). The user 14 then touches the desired unique identifier 21 displayed in the region 42 and the user device 101 dials (e.g. establishes the connection 26) via the modem 208 of the user device 101. Further, touching the sub-box 42 again and the user 14 can be returned to the regular yellow page 40 they were viewing, for example.

Further to the above, each directory entry of the information content 12 (e.g. White pages entry, Yellow pages entry, etc.) can be enabled with a TP button (touch promotion) or PROMO button (e.g. advertisement 44) as it may be called on the displayed content of the information content 12 on the user interface 202. Activation by the user of the button provides for any advertisement 44 to instantly display a promotion for that directory entry along with a phone # (e.g. contact identifier 16) that may be dialed (i.e. selected as the unique contact identifier 21) by touching the dial icon. Further, it is recognised that each entry has a potential for TW (touch website) where the website will be displayed via an icon which, when touched will open the companies website in another browser.

Accordingly, in view of the above-described pages engine 100 and user device 101 operation and components, the system 10 provides for T2T as a short-form for “Touch to Talk” advertising and TP or Promo as a short-form for promotions found within those directory entries (e.g. for contact information 12 embodied as the Yellow pages). T2T advertising facilitates the advertiser to be contacted by touching the T2T button associated with the displayed contact identifiers 16. An example of such advertising would be a Financial Firm trying to get customers to start an investment portfolio or create any other form of investment vehicle. This form of advertising brings vendor and consumer together with just a selection (e.g. touch) of the unique contact identifier 21 associated with the Financial Firm, as displayed on the user interface 202.

We claim:

1. A system for obtaining a unique contact identifier for use by a user device in sending a communication message over a communications network to a target device addressable on the communications network through the unique contact identifier, the system comprising:
a parameter module for receiving at least one search parameter submitted by the user;
a search module for submitting a search request including the search parameter for use in searching a storage containing stored contact information including the unique contact identifier, the stored contact information including multiple contact identifiers, and for receiving a search response including a plurality of contact identifiers of the multiple contact identifiers matching the at least one search parameter;
a presentation module for presenting to a user interface of the user device a contact information set including the plurality of contact identifiers; and
a selection module configured for identifying all respective contact identifiers present in a user selected subset of the contact information set, and for providing the user selected subset including the identified contact identifiers to the user interface for use in selecting the unique contact identifier there from;
wherein the selected unique contact identifier is used by the user device for generating the communication message for sending over the communications network to the target device addressed by the unique contact identifier.

2. The system of claim 1, wherein the plurality of contact identifiers includes non-matching contact identifiers that do not match the at least one search parameter, such that the non-matching contact identifiers are positioned adjacent to the matching contact identifiers in the contact information set.

3. The system of claim 2, wherein the plurality of contact identifiers are selected from the group comprising: telephone numbers and voice over internet protocol (VOIP) numbers.

4. The system of claim 3, wherein the contact information set further includes information associated with the plurality of contact identifiers selected from the group comprising: personal names; business names; personal addresses; business addresses; category of person; and category of business.

5. The system of claim 4, wherein the contact information set is formatted as a series of pages and the plurality of contact identifiers are distributed over one or more pages of the series of pages.

6. The system of claim 5, wherein the series of pages represents a personal directory of personal names and associated contact information.

7. The system of claim 5, wherein the series of pages represents a business directory of business names and associated contact information.

8. The system of claim 7 further comprising the presentation module configured to facilitate navigation of the series of pages by the user through the user interface using turning page animation.

9. The system of claim 2 further comprising the parameter module configured for presenting on the user interface a plurality of search options for use as the at least one search parameter once selected by the user.

10. The system of claim 2 further comprising the selection module configured for disregarding characters present in a user selected subset of the contact information set from the identified contact identifiers, such that the disregarded characters represent contact information non-applicable as the unique contact identifier.

11. The system of claim 2, wherein the contact information set is formatted as a series of pages and the plurality of contact identifiers are distributed over one or more pages of the series of pages.

12. The system of claim 11, wherein the user selected subset includes all contact identifiers in a user selected region of a page of the series of pages, the region being of a predefined size in the vicinity of a location on the page selected by the user.

13. The system of claim 12, wherein the contents of the user selected subset is presented in the user interface in enlarged font in relation to the font size of the presented content of the contact information set.

14. The system of claim 2 further comprising a command module for sending the selected unique contact identifier as a command to a modem of the user device for sending the communication message over the communications network to the target device addressed by the unique contact identifier.

15. The system of claim 2 further comprising an advertisement module for dynamically updating advertising content in the contact information.

16. The system of claim 15 further comprising the advertisement module configured for selectively formatting the advertising content associated with the matching contact identifiers.

17. The system of claim 17 further comprising the advertisement module configured for selectively filtering any of the advertising content from the user selected subset associated with non-matching contact identifiers.

18. The system of claim 12 further comprising the selection module restricting selection of the unique contact identifier from the contact identifiers located outside of the user selected region.

19. The system of claim 2, wherein the user interface is a touch screen.

20. A method for obtaining a unique contact identifier for use by a user device in sending a communication message over a communications network to a target device addressable on the communications network through the unique contact identifier, the method including instructions stored on a computer readable medium for execution by a computer processor, the instructions comprising :
receiving at least one search parameter submitted by the user;
submitting a search request including the search parameter for use in searching a storage containing stored contact information including the unique contact identifier, the stored contact information including multiple contact identifiers;
receiving a search response including a plurality of contact identifiers of the multiple contact identifiers matching the at least one search parameter;
presenting to a user interface of the user device a contact information set including the plurality of contact identifiers;
identifying all respective contact identifiers present in a user selected subset of the contact information set; and
providing the user selected subset including the identified contact identifiers to the user interface for use in selecting the unique contact identifier there from;
wherein the selected unique contact identifier is used by the user device for generating the communication message for sending over the communications network to the target device addressed by the unique contact identifier.

21. The method of claim 20, wherein the plurality of contact identifiers includes non-matching contact identifiers that do not match the at least one search parameter, such that the non-matching contact identifiers are positioned adjacent to the matching contact identifiers in the contact information set.
